(19) United States
(12) Patent Application Publication
(10) Pub. No.: US 2022/0138375 A1
(43) Pub. Date: May 5, 2022

(54) ESTIMATION DEVICE, ESTIMATION METHOD, AND PROGRAM

(71) Applicant: NIPPON TELEGRAPH AND TELEPHONE CORPORATION, Tokyo (JP)

(72) Inventors: Masahiro KOJIMA, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/431,791

(22) PCT Filed: Feb. 7, 2020
(86) PCT No.: PCT/JP2020/004909

§ 371 Date: Aug. 18, 2021

(30) Foreign Application Priority Data
Feb. 21, 2019 (JP) 2019-029769

(51) Int. Cl. G06F 30/20; G06F 17/18

(52) U.S. Cl. CPC G06F 30/20; G06F 2111/10; G06F 17/18

(57) ABSTRACT

To suppress a computation time and accurately estimate parameters of a model representing a probability distribution of censored data.

A parameter estimation unit 20 estimates parameters of a model by optimizing an objective function that is a divergence between a model representing a probability distribution of censored data expressed using a probability density function of observation data, the probability density function being represented by a mixture model of each component representing a distribution of observed values corresponding to each sample of the censored data, and a probability distribution of the censored data obtained from the censored data, the censored data including observation data of a sample with an observed value being observed, observation data of a sample with no observed value being observed, and a variable representing whether or not an observed value is observed for each sample.

### TECHNICAL FIELD

The present invention relates to an estimation apparatus, an estimation method, and a program, and particularly to an estimation apparatus, an estimation method, and a program for estimating parameters of a mixture model from censored data.

### BACKGROUND ART

The “censored data” refers to data, for which an observed value of a sample is at or above (or below) a certain threshold, a value of the sample is not observed, and only information that the value is above the threshold is obtained. Many pieces of data are expressed as the censored data, such as clinical data descriptive of disease onset, human death, and the like, contract history data of the Internet line user, and service usage history data of an e-commerce site. A representative example of a problem in using the censored data is a survival time analysis that estimates a distribution of time required until a device fails, for example. Since a survival time distribution is often multimodal due to the presence of initial failure, deterioration failure, and the like, distribution estimation using a mixture model is widely used.

In order to estimate the parameters of the mixture model from the censored data, an Expectation Maximization for Censored Mixturemodels (EMCM) algorithm proposed in the document (NPL 1) can apply.

### CITATION LIST

### Non Patent Literature

NPL 1: Didier Chauveau. A stochastic em algorithm for mixtures with censored data. Journal of statistical planning and inference, Vol. 46, No. 1, 1995, pp. 1-25.

### SUMMARY OF THE INVENTION

### Technical Problem

However, this approach has the following two problems.

A first problem is the presence of a local optimum solution. Specifically, the first problem is that in the EMCM, while monotonic decrease of an objective function is guaranteed, a convergence destination changes depending on an initial value, and thus, repeated execution from different initial values is required.

A second problem is the need to calculate statistics of truncated distributions (distribution changed to take values only in a certain range) of a probability distribution utilized in a model. Specifically, the second problem is that, except for exceptions such as a one-dimensional truncated normal distribution that is a truncated distribution of a one-dimensional normal distribution, the statistics cannot be analytically calculated, and thus, it is necessary to utilize numerical calculations such as the Monte Carlo method. Since the EMCM is an algorithm that iterates parameter update and calculation of the statistics many times, it may be desirable to avoid repeating numerical calculations in each iteration.

The present invention has been made in view of the above, and has an object to provide an estimation apparatus, an estimation method, and a program capable of suppressing a computation time and accurately estimating parameters of a model representing a probability distribution of censored data.

### Means for Solving the Problem

An estimation apparatus according to the present invention is an estimation apparatus for estimating parameters of a model representing a probability distribution of censored data, the censored data including observation data of a sample with an observed value being observed, observation data of a sample with no observed value being observed, and a variable representing whether or not an observed value is observed for each sample, the estimation apparatus including: an input unit configured to receive input of the censored data; and a parameter estimation unit configured to estimate the parameters of the model by optimizing an objective function that is a divergence between a model representing a probability distribution of the censored data expressed using a probability density function of observation data, the probability density function being represented by a mixture model of each component representing a distribution of observed values corresponding to each sample of the censored data received by the input unit, and a probability distribution of the censored data obtained from the censored data received by the input unit.

An estimation method according to the present invention is an estimation method for estimating parameters of a model representing a probability distribution of censored data, the censored data including observation data of a sample with an observed value being observed, observation data of a sample with no observed value being observed, and a variable representing whether or not an observed value is observed for each sample, the estimation method including: receiving, at an input unit, input of the censored data; and estimating, at a parameter estimation unit, the parameters of the model by optimizing an objective function that is a divergence between a model representing a probability distribution of the censored data expressed using a probability density function of observation data, the probability density function being represented by a mixture model of each component representing a distribution of observed values corresponding to each sample of the censored data received by the input unit, and a probability distribution of the censored data obtained from the censored data received by the input unit.

A program according to the present invention is a program causing a computer to execute processing of estimating parameters of a model representing a probability distribution of censored data, the censored data including observation data of a sample with an observed value being observed, observation data of a sample with no observed value being observed, and a variable representing whether or not an observed value is observed for each sample, the program causing the computer to execute processing including: receiving, by an input unit, input of the censored data; and estimating, by a parameter estimation unit, the parameters of the model by optimizing an objective function that is a divergence between a model representing a probability distribution of the censored data expressed using a probability density function of observation data, the probability density function being represented by a mixture model of each component representing a distribution of observed values corresponding to each sample of the censored data received by the input unit, and a probability distribution of the censored data obtained from the censored data received by the input unit.

According to the estimation apparatus, the estimation method, and the program according to the present invention, the input unit receives input of censored data, the censored data including observation data of a sample with an observed value being observed, observation data of a sample with no observed value being observed, and a variable representing whether or not an observed value is observed for each sample.

The parameter estimation unit estimates parameters of a model by optimizing an objective function that is a divergence between a model representing a probability distribution of censored data expressed using a probability density function of observation data, the probability density function being represented by a mixture model of each component representing a distribution of observed values corresponding to each sample of the censored data which is received by the input unit, and a probability distribution of the censored data obtained from the censored data which is received by the input unit.

In this way, it is possible to suppress a computation time and accurately estimate parameters of a model representing a probability distribution of censored data by estimating the parameters of the model by optimizing an objective function that is a divergence between a model representing a probability distribution of censored data expressed using a probability density function of observation data, the probability density function being represented by a mixture model of each component representing a distribution of observed values corresponding to each sample of the censored data, and a probability distribution of the censored data obtained from the censored data, the censored data including observation data of a sample with an observed value being observed, observation data of a sample with no observed value being observed, and a variable representing whether or not an observed value is observed for each sample.

Moreover, in the estimation apparatus according to the present invention, the model representing the probability distribution of the censored data can be expressed using a probability distribution of the variable represented using the probability density function of the observation data and a length of a time to an observation end given in advance for each sample, and a probability distribution of the observation data with the variable being given, the variable being represented using the probability density function of the observation data and the length of the time to the observation end given in advance for each sample.

In the estimation apparatus according to the present invention, the objective function can be a Kullback-Leibler divergence or an L₂ divergence between the model representing the probability distribution of the censored data and the probability distribution of the censored data.

### Effects of the Invention

According to an estimation apparatus, an estimation method, and a program of the present invention, it is possible to suppress a computation time and accurately estimate parameters of a model representing a probability distribution of censored data.

### BRIEF DESCRIPTION OF DRAWINGS

FIG. 1 is an image diagram illustrating an example of one-dimensional censored data.

FIG. 2 is an image diagram illustrating an example of two-dimensional censored data FIG. 3 is an image diagram illustrating an example of a survival time representation of the one-dimensional censored data.

FIG. 4 is an image diagram illustrating an example of a survival time representation of the two-dimensional censored data.

FIG. 5 is a block diagram illustrating a schematic configuration of a computer serving as an estimation apparatus according to an embodiment of the present invention.

FIG. 6 is a block diagram illustrating a configuration of the estimation apparatus according to an embodiment of the present invention.

FIG. 7 is a flowchart illustrating an estimation processing routine of the estimation apparatus according to the embodiment of the present invention.

### DESCRIPTION OF EMBODIMENTS

Hereinafter, an embodiment of the present invention will be described with reference to the drawings.

Principle of Estimation Apparatus According to Embodiment of the Present Invention First, a principle of an embodiment of the present invention will be described.

The embodiment of the present invention establishes two schemes using different objective functions illustrated below. A first one is an estimation scheme based on Kullback-Leibler (KL) divergence minimization between probability distributions, and a second one is an estimation scheme based on L₂ divergence minimization between probability distributions. The first estimation scheme can estimate the parameters in a very simple repeated calculation, and the second estimation scheme can analytically estimate the parameters even without requiring repeated iterations.

The point for establishing the schemes according to the embodiment of the present invention is the use of an approach called an examplar based model (hereinafter, referred to as an emb) (Reference document 1).
[Reference document 1] Danial Lashkari and Polina Golland, “Convex clustering with exemplar-based models”, in Advances in Neural Information Processing Systems, 2008, pp. 825-832.

In the emb approach, the parameters of each component of a mixture model are not explicitly handled as parameters, and each component is placed at a point where a data point is present. This can establish an algorithm that converges to a global optimum solution by formulation estimating only a mixing ratio (weighting parameters for each component). The scheme according to the embodiment of the present invention may be considered as one obtained by developing this approach such that censored data can be used as input.

Furthermore, although statistics of truncated distributions required for the EMCM described above are necessary for the estimation of the parameters of the component, adoption of this approach allows a scheme not requiring the repeated numerical calculations to be established.

Note that the method disclosed in the document (Reference document 1) proposes a scheme for performing the emb by the KL divergence minimization using normal data, but cannot handle the censored data.

A document (Reference document 2) also considers the approach using the L₂ divergence for a function of error in the probability distribution, but assumes a situation in which the normal data is input rather than the censored data.
[Reference document 2] David W. Scott, “Parametric Statistical Modeling by Minimum Integrated Square Error”, Technometrics, Vol. 43, No. 3, 2001, pp. 274-285.

In addition, a document (Reference document 3) is a study using censored data and L₂ divergence, but assumes only a case that a simple unimodal distribution such as an exponential distribution and a Weibull distribution is used as a model.
[Reference document 3] Srabashi Basu, Ayanendranath Basu, and MCJones, “Robust and Efficient Parametric Estimation for Censored Survival Data”, Annals of the Institute of Statistical Mathematics, Vol. 58, No. 2, 2006, pp. 341-355.

Preparation

### Censored Data

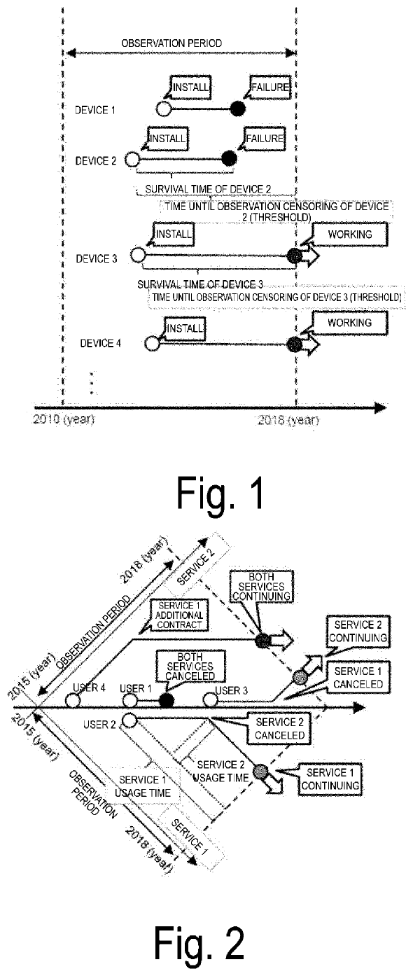

First, the censored data will be described. FIG. 1 illustrates an example of one-dimensional censored data. As illustrated in the example of FIG. 1, device failure data, which is a representative example of the censored data, is used for the description.

In the device failure data, a time of installation of each device and a time of failure when a failure occurred are recorded. As for devices 1 and 2, since failures occurred during an observation period, the times of the failures are recorded. On the other hand, as for devices 3 and 4, since failures did not occur during the observation period and the observation was ended, time of failures are not recorded.

However, it can be read that because any of the devices 3 and 4 may inevitably fail, the times of failures thereof are at and after a time of observation end. As described above, data including combination of data with observed values (time of failure) known like as for the devices 1 and 2 and data with observed values (time of failure) known to be equal to or more a certain value like as for the devices 3 and 4 is referred to as censored data.

The device failure data in FIG. 1 is one-dimensional censored data, but this scheme can also handle two or more dimensional censored data, and thus, a description thereof is given here.

FIG. 2 illustrates two-dimensional censored data representing user's usage periods of certain two services. In the case of FIG. 2, a time of start to use (at least one) service by the user and a time of additional contract or cancellation of each service are recorded.

A user 1 simultaneously starts to use both services, and simultaneously cancels during the observation period, so the cancellation times of both services are recorded. A user 2 simultaneously starts to use both services, and cancels only a service 2 during the observation period. A user 3 simultaneously starts to use both services, and cancels only a service 1 during the observation period. A user 4 start to use the service 2 first, and additionally contracts the service 1 during the observation period. Thus, because of observation censoring, a cancellation time of the service 1 of the user 2, a cancellation time of the service 2 of the user 3, and a cancellation time of the services 1 and 2 of the user 4 are not recorded.

In this way, the two-dimensional censored data includes three types of censored data in which dimensions of censored values are different. In general, n-dimensional censored data includes 2ⁿ−1 types of censorings. Note that, hereinafter, an example in which whether the observation is censored in each dimension is determined will be described, but the same approach can be used in a situation where all elements are not observed when any one of the elements is censored.

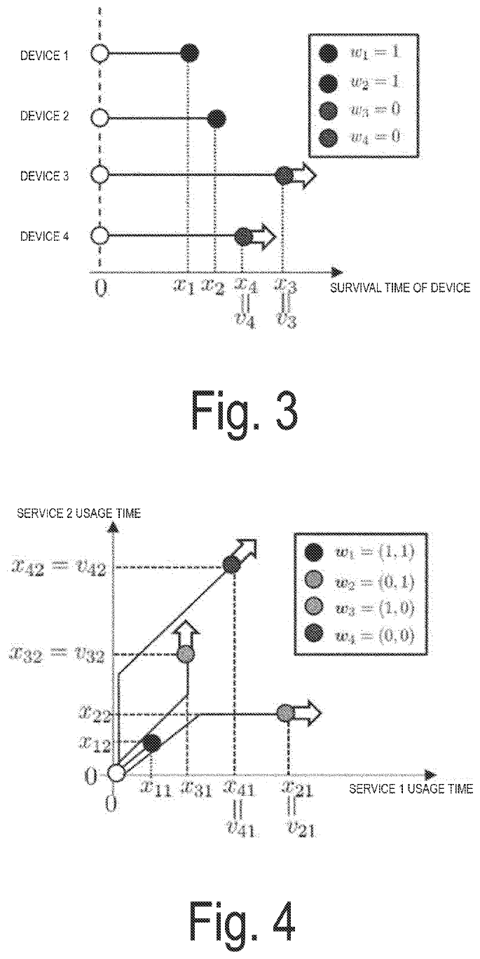

Here, a definition of the censored data is given. For simplicity of handling, the observation data is expressed using a survival time (time from installation of a device to failure, time from service contract to cancellation), rather than a calendar time as in FIG. 1. The observation data in FIG. 1 represented in the survival time is illustrated in FIG. 3, and the observation data in FIG. 2 represented in the survival time is illustrated in FIG. 4. To define as a multi-dimensional censored data. FIG. 4 is used for the illustrative example.

Censored data is written as:

[symbol]

={xᵢ,wᵢ}ᵢ₌₁ⁿ

Here both
xᵢ
and
wᵢ
are d-dimensional vectors, where

xᵢ∈ [symbol] ^{d}^{ₓ}

and

wᵢ∈{0,1}^{d}^{ₓ}.

xᵢⱼ represents a usage time of a service j of a user i, and wᵢⱼ represents whether a cancellation time of the service j of the user i is recorded (wᵢⱼ=1) or is not recorded due to censoring (wᵢⱼ=0). Similarly, a length of a time to an observation end time of a i-th user is written as:

vᵢ∈ [symbol] ^{d}^{ₓ}

vᵢⱼ represents a length from a usage start time to an observation end time of the service j of the user i. In a case that no observed value is observed due to censoring (wᵢⱼ=0), it is assumed that xᵢⱼ=vᵢⱼ is set.

Mixture Model

Next, a model used in the embodiment of the present invention will be described. A probability density function of an observed value, represented by a mixture model, is generally defined by the following an equation (1):

[Math. 1]

f(x|θ)=Σₖ₌₁^{K}θₖψₖ(x)=θ^{T}ψ(x). (1)

Where K represents the number of mixtures, and

ψₖ(x)
represents a probability distribution of the k-th component. For the probability distribution of a component
ψₖ(x)
a Gaussian distribution expressed by, for example, the following equation can be used.

$$\begin{matrix}[ Math . 2 ] & \\ {ψ}_{k} ( x ) = 𝒩 ( x \vert {μ}_{k} , {σ}^{2} ) = \frac{1}{{( \sqrt{2 {πσ}^{2}} )}^{{d}_{x}}} exp ( - \frac{{‖ x - {μ}_{k} ‖}^{2}}{2 {σ}^{2}} ) & \end{matrix}$$

Where

μₖ
and a represent a mean and a standard deviation of the Gaussian distribution, respectively. However, in accordance with the approach of the ebm (Reference document 1), parameters of the probability distribution of the component
(In a case of Gaussian distribution, μ₁, . . . , μ_{K})
is set as

(μ₁, . . . ,μₙ)=(x₁, . . . ,xₙ)

with K=n, and such that each corresponds to an observation data point. In this case, the probability density function of the observed value is represented by a mixture model of each component for each piece of the observation data, and the mean of the Gaussian distributions included in each component is used as the corresponding observed value. Since the scheme handles the censored data, K=n is set, and in a case that the value is observed (wᵢⱼ=1), μᵢⱼ=xᵢⱼ may be set, otherwise (wᵢⱼ=0), μᵢⱼ=xᵢⱼ+ε may be set. ε represents a randomly generated value from a probability distribution (e.g., an exponential distribution) that takes a value of 0 or more. In a case that the number of pieces of data is large, for example, only 100 pieces of data that are randomly selected may be used, or a component set based prior knowledge may be used. The standard deviation a can be determined by cross validation or the like.

A generative process of the censored data

[symbol]

={xᵢ,wᵢ}

when using the model described above can be described as follows. First, with the length of the time to the observation end for each sample
vᵢ
being known, a variable representing whether censoring occur
wᵢ
is generated in accordance with a probability distribution of an equation (2) below:

$$\begin{matrix}[ Math . 3 ] & \\ \begin{matrix}P ( {w}_{i} \vert θ ) = F ( {w}_{i} \vert θ ; {v}_{i} ) \\ = {\int }_{{v}_{i}^{c}}^{∞} \{ {\int }_{- ∞}^{{v}_{i}^{o}} f ( {x}_{i} \vert θ ) {dx}_{i}^{o} \} {dx}_{i}^{c} \\ = {\sum }_{k = 1}^{K} {θ}_{k} {Ψ}_{k}^{w} ( {w}_{i} ; {v}_{i} ) \\ = {θ}^{T} {Ψ}_{i}^{w} ,\end{matrix} & ( 2 ) \\ {Ψ}_{k}^{w} ( {w}_{i} ; {v}_{i} ) = {\int }_{{v}_{i}^{c}}^{∞} \{ {\int }_{- ∞}^{{v}_{i}^{c}} {ψ}_{k} d ( x ) {dx}^{o} \} {dx}^{c} . & ( 3 )\end{matrix}$$

Where among

xᵢ
and
vᵢ,
a set of elements in the case of wᵢⱼ=1 with observed values being observed is set as below:

xᵢ^{o}={xᵢⱼ|wᵢⱼ=1},vᵢ^{o}={vᵢⱼ|wᵢⱼ=1}

Similarly, a set in the case of wᵢⱼ=0 with no observed value being observed is set as below:

xᵢ^{c}={xᵢⱼ|wᵢⱼ=0},vᵢ^{c}={vᵢⱼ|wᵢⱼ=0}

In a case that the elements with the observed values being observed are not distinguished from the elements with no observed value being observed, those are referred to as observation data. In a case that a standard probability distribution, such as the Gaussian distribution of the equation (2) above is used for the probability distribution of the component
ψₖ(x),
ψₖ^{w}(wᵢ;vᵢ)
be calculated analytically using a cumulative density function.

In a case that

wᵢ≠0

and at least one observed element is present,
xᵢ
is generated in accordance with a distribution expressed by an equation (4) below.

[Math. 4]

P(xᵢ|wᵢ,θ)=δ(xᵢ^{c}−vᵢ^{c})fₜᵣ(xᵢ^{o}|wᵢ,θ) (4)

Where

δ(⋅)
is a delta function, and fₜᵣ represents a truncated distribution of a distribution obtained by marginalizing f with respect to the not observed element and expressed by an equation below.

$$\begin{matrix}[ Math . 5 ] & \\ {f}_{tr} ( {x}_{i}^{o} \vert {w}_{i} , θ ) = \{ \begin{matrix}\frac{{f}^{{x}^{o}} ( {x}_{i}^{o} \vert θ )}{F ( {w}_{i} \vert θ ; {v}_{i} )} & ( if {x}_{i}^{o} \leq {v}_{i} and {x}_{i}^{c} \geq {v}_{i} ) \\ 0 & ( otherwise )\end{matrix} & \end{matrix}$$

Where, fₜᵣ is according to equations (5) and (6) below.

$$\begin{matrix}[ Math . 6 ] & \\ \begin{matrix}{f}^{{x}^{o}} ( {x}_{i}^{o} \vert θ ) = {\int }_{{v}^{c}}^{∞} f ( {x}_{i} \vert θ ) {dx}_{i}^{c} \\ = {\sum }_{k = 1}^{K} {θ}_{k} {Ψ}_{ik}^{{x}^{o}} \\ = {θ}^{T} {Ψ}_{i}^{{x}^{o}}\end{matrix} & ( 5 ) \\ {Ψ}_{ik}^{{x}^{o}} = {Ψ}_{k}^{{x}^{o}} ( {x}_{i}^{o} ; {v}_{i} ) = {\int }_{{v}^{c}}^{∞} {ψ}_{k} ( {x}_{i} ) {dx}_{i}^{c} & ( 6 )\end{matrix}$$

In a case that the component is the Gaussian distribution of the equation (2) described above,

ψᵢₖ^{x}^{^{o}}
is expressed as below:

ψᵢₖ^{x}^{^{o}}= [symbol] (xᵢ^{o}|μₖ^{x}^{ᵢ}^{^{o}},σ²)∫ᵥ_{ᵢ}_{^{o}}^{∞} [symbol] (xᵢ^{c}|μₖ^{x}^{ᵢ}^{^{o}},σ²)dxᵢ^{c}

### Here,

μₖ^{x}^{ᵢ}^{^{o}}, μₖ^{x}^{ᵢ}^{^{c}}
are vectors obtained by extracting elements of dimensions corresponding to
xᵢ^{o}
and
xᵢ^{c}
from
μₖ, respectively.

In a case that

wᵢ=0
and no observed element is present, an expression with only a delta function is given as expressed by an equation (7) below.

[Math. 7]

P(xᵢ|wᵢ=0,θ)=δ(xᵢ^{c}−vᵢ) (7)

Accordingly, in summary, a generative probability of each piece of censored data is given by an equation (8) below:

[Math. 8]

P(xᵢ,wᵢ|θ)=P(xᵢ|wᵢ,θ)P(wᵢ|θ) (8)

KL Divergence and L₂ Divergence

Next, the divergences utilized in defining an objective function of proposed schemes are described. As is well known, the Kullback-Leibler (KL) divergence for probability distributions p(x) and q(x) is defined by an equation (9) below:

$$\begin{matrix}[ Math . 9 ] & \\ \begin{matrix}KL ( p , q ) = {𝔼}_{q} [ log \frac{q ( x )}{p ( x )} ] \\ = \int q ( x ) log q ( x ) dx - \int q ( x ) log p ( x ) dx\end{matrix} & ( 9 )\end{matrix}$$

In addition, in the embodiment of the present invention, a case in which the L₂ divergence (Reference document 2) defined below is also used will be described (equation (10) below).

$$\begin{matrix}[ Math . 10 ] & \\ \begin{matrix}{L}_{2} ( p , q ) = \int {\{ p ( x ) - q ( x ) \}}^{2} dx \\ = \int {\{ p ( x ) \}}^{2} dx + \int {\{ q ( x ) \}}^{2} dx - 2 \int p ( x ) q ( x ) dx\end{matrix} & ( 10 )\end{matrix}$$

The L₂ divergence is defined as a squared error of two probability density functions. Which divergence should be used depends on the problem. Thus, in the embodiment of the present invention, two types of schemes have been established so that any divergence can be used.

Estimation by Optimization of KL Divergence

First, a proposed scheme in a case that the KL divergence is used as an objective function is described. The KL divergence between a model representing a probability distribution of censored data
P(x, w|θ)
and a true probability distribution obtained from the censored data

### P*(x, w)

is given by an equation (11) below, in accordance with the definition of the equation (9) above.

$$[ Math . 11 ]$$

$${𝒟}_{KL} ( θ ) = {𝔼}_{{P}^{*} ( {x}_{i} , {w}_{i} )} [ log \frac{{P}^{*} ( {x}_{i} , {w}_{i} )}{P ( {x}_{i} , {w}_{i} \vert θ )} ] \qquad ( 11 )$$

This can be deformed as in an equation (12) below.

$$[ Math . 12 ]$$

$${𝒟}_{KL} ( θ ) = {\sum }_{{w}_{i} \neq 0} {P}^{*} ( {w}_{i} ) {𝔼}_{{P}^{*} ( {x}_{i} , {w}_{i} )} [ log \frac{{P}^{*} ( {x}_{i} \vert {w}_{i} ) {P}^{*} ( {w}_{i} )}{P ( {x}_{i} \vert {w}_{i} , θ ) P ( {w}_{i} \vert θ )} ] + {P}^{*} ( {w}_{i} = 0 ) log \frac{{P}^{*} ( {w}_{i} = 0 )}{P ( {w}_{i} = 0 \vert θ )} = {\sum }_{{w}_{i} \neq 0} {P}^{*} ( {w}_{i} ) {𝔼}_{{P}^{*} ( {x}_{i}^{o} , {w}_{i} )} [ log \frac{{P}^{*} ( {x}_{i}^{o} \vert {w}_{i} )}{{f}^{{x}^{o}} ( {x}^{o} \vert θ )} ] + {P}^{*} ( {w}_{i} = 0 ) log \frac{{P}^{*} ( {w}_{i} = 0 )}{P ( {w}_{i} = 0 \vert θ )} = {\sum }_{{w}_{i} \neq 0} {P}^{*} ( {w}_{i} ) {𝔼}_{{P}^{*} ( {x}^{o} \vert {w}_{i} )} [ - log {f}^{{x}^{o}} ( {x}^{o} \vert θ ) ] - {P}^{*} ( {w}_{i} = 0 ) log F ( {w}_{i} = 0 \vert θ ; {v}_{i} ) + Const \qquad ( 12 )$$

Constant terms are removed and expected values for the true distribution unknown

### P*

are replaced with sample means to derive an equation (13) below.

$$[ Math . 13 ]$$

$$\begin{matrix}{\hat{𝒟}}_{KL} ( θ ) = - \frac{1}{n} \{ {\sum }_{\{ i \vert {w}_{i} \neq 0 \}} log {f}^{{x}^{o}} ( {x}_{i}^{o} \vert θ ) + {\sum }_{\{ i \vert {w}_{i} = 0 \}} log F ( 0 \vert θ ; {v}_{i} ) \} \\ = - \frac{1}{n} \{ {\sum }_{\{ i \vert {w}_{i} \neq 0 \}} log ( {θ}^{T} {Ψ}_{i}^{{x}^{o}} ) + {\sum }_{\{ i \vert {w}_{i} = 0 \}} log ( {θ}^{T} {Ψ}_{i}^{w} ) \} .\end{matrix} \qquad ( 13 )$$

Where

[symbol]

_{KL}(θ)
is an amount capable of being calculated from the data, and is used as an objective function to derive an algorithm. Specifically, an optimization problem of an equation (14) below may be solved.

$$[ Math . 14 ]$$

$$\hat{θ} = {argmin}_{θ} [ {\hat{𝒟}}_{KL} ( θ ) s . t . {θ}_{k} \geq 0 , \vert θ \vert = 1.0 . \qquad ( 14 )$$

Here, constraint conditions (where the elements of the parameters are equal to or more than 0 and the sum is 1) is for the probability distribution of the mixture model f. Using the Lagrange method of undetermined multipliers, it can be seen that the solution for the optimization problem described above satisfies an equation (15) below.

$$[ Math . 15 ]$$

$${\hat{θ}}_{k} = \frac{1}{n} \{ {\sum }_{\{ i \vert {w}_{i} \neq 0 \}} \frac{{θ}_{k} {Ψ}_{k}^{{x}^{o}} ( {x}_{i}^{o} ; {v}_{i} )}{{θ}^{T} {Ψ}_{i}^{{x}^{o}}} + {\sum }_{\{ i \vert {w}_{i} \neq 0 \}} \frac{{θ}_{k} {Ψ}_{k}^{w} ( {w}_{i} ; {v}_{i} )}{{θ}^{T} {Ψ}_{i}^{w}} \} \qquad ( 15 )$$

Thus, based on the equation (15) above, optimization is possible by repeating the updates of

\hat{θ}.
Note that, as in the scheme of Reference document 1, in order to reduce the amount of calculation and accelerate the convergence, in a case that θₖ is smaller than a certain threshold (e.g., 10⁻³/n) during the parameter update, θₖ=0 may be set, and then, a re-normalization operation may be performed to adjust the overall to satisfy the sum to one.

Estimation by Optimization of L₂ Divergence

Next, a proposed scheme in a case that the L₂ divergence is used is described. Unlike the KL divergence, an objective function is not directly defined from the definition of the L₂ divergence, and a new objective function is defined by focusing the objective function when using the KL divergence.

Focusing on the objective function (equation (12)) when using the KL divergence, it can be seen that two terms of a term corresponding to the KL divergence of a marginal distribution of the mixture model f

f^{x}^{^{o}}(xᵢ^{o}|θ) and
the true distribution of the observed values with variables being given

### P*(x|wᵢ),

and a term corresponding to a log-likelihood ratio using the distribution of the model of variable representing that the observed value is not observed

### P(wᵢ=0|θ) and

the true distribution

### P*(wᵢ=0)

are weighted by

### P(wᵢ)

and summed.

Based on this insight, the objective function can be designed as the follow equation by replacing the parts using the KL divergence/log-likelihood ratio in each of these two terms with the L₂ divergence.

$$[ Math . 16 ]$$

$${𝒟}_{L 2} ( θ ) = {\sum }_{{w}_{i} \neq 0} {P}^{*} ( {w}_{i} ) \int {( {f}^{{x }^{o}} ( {x}_{i}^{o} \vert θ ) - {P}^{*} ( {x}_{i}^{o} \vert {w}_{i} ) )}^{2} {dx}_{i}^{o} + {P}^{*} ( {w}_{i} = 0 ) {( F ( {w}_{i} = 0 \vert θ ; {v}_{i} ) - {P}^{*} ( {w}_{i} = 0 ) )}^{2}$$

This is deformed to obtain an equation below:

$${𝒟}_{L 2} ( θ ) = {\sum }_{{w}_{i} \neq 0} {P}^{*} ( {w}_{i} ) \int {\{ {f}^{{x }^{o}} ( {x}_{i}^{o} \vert θ ) \}}^{2} {dx}_{i}^{o} - 2 {\sum }_{{w}_{i} \neq 0} \int {P}^{*} ( {x}_{i}^{o} , {w}_{i} ) {f}^{{x}^{o}} ( {x}_{i}^{o} \vert θ ) {dx}_{i}^{o} + {P}^{*} ( {w}_{i} = 0 ) {\{ F ( {w}_{i} = 0 \vert θ ; {v}_{i} ) \}}^{2} - 2 {\{ {P}^{*} ( {w}_{i} = 0 ) \}}^{2} F ( {w}_{i} = 0 \vert θ ; {v}_{i} ) + Const$$

Further, consider optimization of an equation below obtained by removing the constant terms (Const) and replacing the means for the true distribution with the sample means.

$$[ Math . 16 ]$$

$${\hat{𝒟}}_{L 2} ( θ ) = \frac{1}{n} ( {\sum }_{\{ i \vert {w}_{i} \neq 0 \}} \int {\{ {f}^{{x}^{o}} ( {x}_{i}^{o} \vert θ ) \}}^{2} {dx}_{i}^{o} - 2 {\sum }_{\{ i \vert {w}_{i} \neq 0 \}} {f}^{{x}^{o}} ( {x}_{i}^{o} \vert θ ) + {\sum }_{\{ i \vert {w}_{i} \neq 0 \}} {F ( {w}_{i} \vert θ ; {v}_{i} )}^{2} \} - 2 \frac{{n}_{0}}{{n}^{2}} {\sum }_{\{ i \vert {w}_{i} = 0 \}} F ( {w}_{i} \vert θ ; {v}_{i} ) .$$

Where

n_{w}=Σᵢ₌₁ⁿI(wᵢ=w)

is set. This is used as the objective function to derive the algorithm. [symbol]
_{L2}(θ)
can be expressed in a matrix-vector form as in equations (16) and (17) below.

$$[ Math . 17 ]$$

$$\begin{matrix}{\hat{𝒟}}_{L 2} ( θ ) = {θ}^{T} \hat{G} θ - 2 {\hat{g}}^{T} θ + {θ}^{T} \hat{H} θ - 2 {\hat{h}}^{T} θ & ( 16 ) \\ = {θ}^{T} ( \hat{G} + \hat{H} ) θ - 2 ( {\hat{g}}^{T} + {\hat{h}}^{T} ) θ , & ( 17 )\end{matrix}$$

Where the above is according to equations (18) to (20) below.

$$[ Math . 18 ]$$

$$\begin{matrix}\hat{G} = \frac{1}{n} {\sum }_{\{ i \vert {w}_{i} \neq 0 \}} \int {{Ψ}_{i}^{{x}^{o}} ( {Ψ}_{i}^{{x}^{o}} )}^{T} {dx}_{i}^{o} & ( 18 ) \\ \hat{H} = \frac{1}{n} {\sum }_{\{ i \vert {w}_{i} \neq 0 \}} {Ψ}^{w} ( {w}_{i} = 0 ; {v}_{i} ) {{Ψ}^{w} ( {w}_{i} = 0 ; {v}_{i} )}^{T} , & ( 19 ) \\ \hat{g} = \frac{1}{n} {\sum }_{\{ i \vert {w}_{i} \neq 0 \}} {Ψ}_{i}^{{x}^{o}} , \hat{h} = \frac{{n}_{0}}{{n}^{2}} {\sum }_{\{ i \vert {w}_{i} = 0 \}} {Ψ}_{i}^{w} , & ( 20 )\end{matrix}$$

Also, in a case that a Gaussian distribution is used for the distribution of the components,

Ĝ
is an analytically computable value and can be expressed as an equation (21) below.

$$[ Math . 19 ]$$

$$\begin{matrix}{\hat{G}}_{kk \text{?}} = \frac{1}{n} {\sum }_{\{ i \vert {w}_{i} \neq 0 \}} {( \int {{Ψ}_{i}^{{x}^{o}} ( {Ψ}_{i}^{{x}^{o}} )}^{T} {dx}_{i}^{o} )}_{kk \text{?}} \\ = \begin{matrix}\frac{1}{n} {\sum }_{\{ i \vert {w}_{i} \neq 0 \}} 𝒩 ( {μ}_{\text{?}}^{{x}_{i}^{o}} \vert {μ}_{\text{?}}^{{x}_{i}^{o}} , 2 {σ}^{2} ) {\int }_{\text{?}}^{∞} 𝒩 ( {x}_{i}^{o} \vert {μ}_{\text{?}}^{{x}_{i}^{o}} , {σ}^{2} ) {dx}_{i}^{o} \\ {\int }_{\text{?}}^{∞} 𝒩 ( {x}_{i}^{o} \vert {μ}_{\text{?}}^{{x}_{i}^{o}} , {σ}^{2} ) {dx}_{i}^{o}\end{matrix} \\ \text{?} \text{indicates text missing or illegible when filed}\end{matrix} \qquad ( 21 )$$

It is noted that, in the equation (21) above, regarding summing up for

w,
dₓ_{^{o}}
or
μₖ^{x}^{ᵢ}^{^{o}}
is a value different depending on a value of
w.
It is found from this that the objective function is expressed in a secondary form for
θ.
Accordingly, an estimate value of the parameter can be obtained by solving a constrained secondary optimization problem described below.

$$[ Math . 20 ]$$

$$\hat{θ} = {argmin}_{θ} [ {\hat{𝒟}}_{L 2} ( θ ) s . t . {θ}_{k} \geq 0 , \vert θ \vert = 1.0 . \qquad ( 22 )$$

A numerical solver can be used to directly solve the optimization problem of an equation (22) above. At this time, an optimization problem described below to which a normalization term is added may be solved.

$$[ Math . 21 ]$$

$$\hat{θ} = {argmin}_{θ} [ {\hat{𝒟}}_{L 2} ( θ ) + {βθ}^{T} θ ] s . t . {θ}_{k} \geq 0 , \vert θ \vert = 1.0$$

Where, β represents a hyper parameter. In addition, an approximate method described below may be used, for example. An optimum solution for a problem in which the constraint is removed from the optimization problem of the equation (22) above is found as expressed in equations (23) and (24) below.

$$[ Math . 22 ]$$

$$\begin{matrix}\tilde{θ} = {argmin}_{θ} [ {\tilde{𝒟}}_{L 2} ( θ ) + {βθ}^{T} θ ] & ( 23 ) \\ = {( G + \hat{H} + β {I}_{K} )}^{- 1} ( \hat{g} + \hat{h} ) & ( 24 )\end{matrix}$$

Where,

### θ^{T}θ

is a normalization term and β is a hyper parameter, which has an effect of preventing parameter dissipation.
θ
has a value equal to or more than 0 and the sum is 1, and thus,
\hat{θ}
satisfying a condition is obtained by processing of an equation (25) below.

$$[ Math . 23 ]$$

$$\hat{θ} = \frac{max ( \tilde{θ} , 0 )}{\vert max ( \tilde{θ} , 0 ) \vert} \qquad ( 25 )$$

Where,

|⋅|
represents
a [symbol] ₁ norm.

In the embodiment of the present invention, parameters of a model are estimated using any of two schemes described above to make it possible to suppress a computation time and accurately estimate the parameters of the model representing a probability distribution of censored data.

Configuration of Estimation Apparatus According to Embodiment of the Present Invention

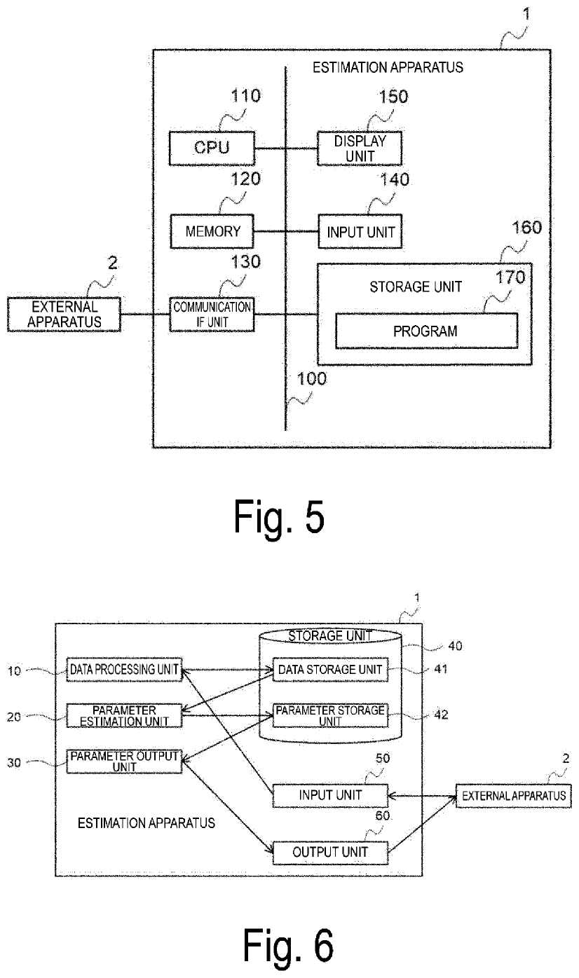

A configuration of an estimation apparatus 1 according to the embodiment of the present invention will be described with reference to FIGS. 5 and 6. FIG. 5 is a block diagram illustrating a schematic configuration of a computer serving as the estimation apparatus 1 according to the embodiment of the present invention. FIG. 6 is a block diagram illustrating a configuration of the estimation apparatus 1 according to the embodiment of the present invention.

As illustrated in FIG. 5, the estimation apparatus 1 is configured to include a computer including a CPU 110, a memory 120 such as a RAM, a communication interface (IF) unit 130, an input unit 140 such as a keyboard, a display unit 150 such as a display, and a storage unit 160, such as a ROM, that stores a program 170 for executing an estimation processing routine described below. The CPU 110, the memory 120, the communication IF unit 130, the input unit 140, the display unit 150, and the storage unit 160 are connected with each other via a bus 100. Furthermore, the communication IF unit 130 is connected to an external apparatus 2 via a communication line such as a LAN cable. Note that the communication IF unit 130 may be configured to be connected to the external apparatus 2 via a network (not illustrated).

As illustrated in FIG. 6, the estimation apparatus 1 according to the present embodiment includes a data processing unit 10, a parameter estimation unit 20, a parameter output unit 30, a storage unit 40, an input unit 50, and an output unit 60.

The data processing unit 10 stores, in a data storage unit 41, censored data

[symbol]

={xᵢ, wᵢ} including
xᵢ^{o}
that is observation data of a sample with an observed value being observed, the observed value being received by the input unit 50,
xᵢ^{c}
that is observation data of a sample with no observed value being observed, and
wᵢ
that is a variable representing whether or not an observed value is observed for each sample. The sample refers to, for example, each device in the examples of FIGS. 1 and 3 described above, and each user in the example of FIGS. 2 and 4.

The parameter estimation unit 20 estimates parameters of a model

θ
by optimizing an objective function that is a divergence between
P(x, w|θ)
that is a model representing a probability distribution of censored data

[symbol]

expressed using a probability density function of observation data, the probability density function being represented by a mixture model of each component representing a distribution of observed values corresponding to each sample of the censored data

[symbol]

which is received by the input unit 50
and

### P*(x, w)

that is a true probability distribution of the censored data

[symbol]

obtained from the censored data

[symbol]

received by the input unit 50.

Specifically, the parameter estimation unit 20 first determines the true probability distribution

### P*(x, w)

of the censored data

[symbol]

Next, the parameter estimation unit 20 estimates the parameters assuming that the objective function is a KL divergence or an L₂ divergence between

P(x, w|θ)
that is a model representing a probability distribution of the censored data

[symbol]

and

### P*(x, w)

that is a true probability distribution of the censored data

[symbol]

Here,

P(x, w|θ)
that is the model representing the probability distribution of the censored data is expressed, as expressed by the equation (8) above, using
P(xᵢ|wᵢ, θ)
that is a probability distribution of observation data represented using a probability density function of the observation data and a length of a time to an observation end given in advance for each sample, and

### P(wᵢ|θ)

that is a probability distribution of variables with the variables being given, the variables being represented using the probability density function of the observation data and the length of the time to the observation end given in advance for each sample.

The parameter estimation unit 20, in a case of using the KL divergence, estimates the parameters by repeating the parameter update of the equation (15) above. The parameter estimation unit 20, in a case of using the L₂ divergence, estimates the parameters using the equations (24) and (25) above.

Then, the parameter estimation unit 20 stores the estimated parameters

θ
in a parameter storage unit 42.

The parameter output unit 30 acquires the parameters

θ
in the parameter storage unit 42 to pass the acquired parameters
θ
to the parameter output unit 30.

The storage unit 40 includes the data storage unit 41 and the parameter storage unit 42. The censored data

[symbol]

is stored in the data storage unit 41. The parameters of the model
θ
are stored in the parameter storage unit 42.

The input unit 50 receives the censored data

[symbol]

input from the external apparatus 2. Then, the input unit 50 passes the received censored data

[symbol]

to the data processing unit 10.

The output unit 60 outputs the parameters of the model

θ
received from the parameter output unit 30 to the external apparatus 2.

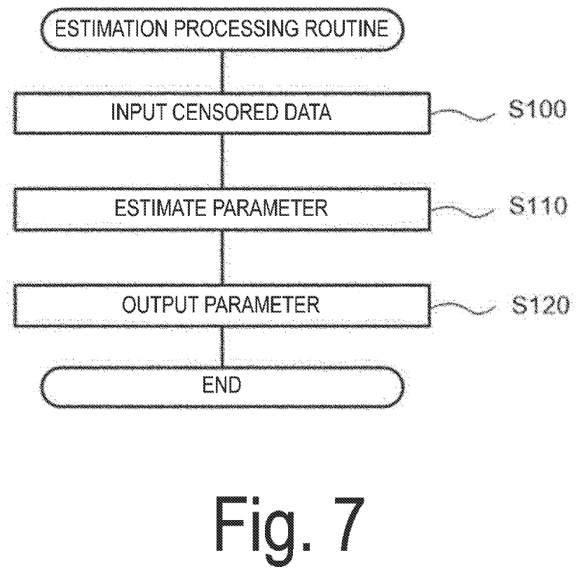

Action of Estimation Apparatus According to Embodiment of the Present Invention FIG. 7 is a flowchart illustrating an estimation processing routine according to the embodiment of the present invention.

Once the censored data

[symbol]

={xᵢ, wᵢ}
is input to the input unit 50, an estimation processing routine illustrated in FIG. 7 is executed in the estimation apparatus 1.

First, in step S100, the input unit 50 receives input of censored data

[symbol]

={xᵢ, wᵢ} including
that is observation data of a sample with an observed value being observed,
xᵢ^{c}
that is observation data of a sample with no observed value being observed, and
wᵢ
that is a variable representing whether or not an observed value is observed for each sample. The input unit 50 accepts an input of a length of a time to an observation end time for each sample i.

In step S110, the parameter estimation unit 20 estimates the parameters assuming that the objective function is a KL divergence or an L₂ divergence between

P(x, w|θ)
that is a model representing a probability distribution of the censored data

[symbol]

and

### P*(x, w)

that is a true probability distribution of the censored data

[symbol]

by repeating the parameter update of the equation (15) above, or using the equations (24) and (25) above.

In step S120, the output unit 60 outputs the parameters

θ
estimated in step S110 above.

As described above, according to the estimation apparatus in the embodiment of the present invention, the objective function described below is optimized to make it possible to suppress a computation time for estimating parameters of a model and accurately estimate the parameters of the model representing a probability distribution of censored data. Here, the objective function is given by a divergence between a model representing a probability distribution of censored data described below and a probability distribution of the censored data obtained from the censored data. Here, the model representing the probability distribution of the censored data is expressed using a probability density function of the observation data described below. The probability density function is represented by a mixture model of each component representing a distribution of observed values corresponding to each sample of the censored data, the censored data including observation data of a sample with an observed value being observed, observation data of a sample with no observed value being observed, and a variable representing whether or not an observed value is observed for each sample.

Note that the present invention is not limited to the above-described embodiment, and various modifications and applications may be made without departing from the gist of the present invention.

For example, in the embodiments described above, the case that the KL divergence or the L₂ divergence is used as a divergence is described, but the present invention is not limited thereto, and another divergence can be used.

Further, in the embodiment described above, the description is given assuming the censored data that is time-series data, but the present invention is not limited thereto, and the present invention is also applicable to any censored data that is not time-series data.

Furthermore, the estimation apparatus 1 according to the embodiment described above is described as that configured such that the processing of each part is established as a program, installed on a computer used as an estimation apparatus, and executed, but may be configured to be distributed via a network.

In addition, although an embodiment in which the programs are installed in advance has been described in the present specification of the present application, such programs can be provided by being stored in a computer-readable recording medium.

### REFERENCE SIGNS LIST

1 Estimation apparatus
2 External apparatus
10 Data processing unit
20 Parameter estimation unit
30 Parameter output unit
40 Storage unit
41 Data storage unit
42 Parameter storage unit
50 Input unit
60 Output unit
100 Bus
110 CPU
120 Memory
130 Communication IF unit
140 Input unit
150 Display unit
160 Storage unit
170 Program

1. An estimation apparatus for estimating parameters of a model representing a probability distribution of censored data, the censored data including observation data of a sample with an observed value being observed, observation data of a sample with no observed value being observed, and a variable representing whether or not an observed value is observed for each sample, the estimation apparatus comprising:
an input receiver configured to receive input of the censored data; and
a parameter estimator configured to estimate the parameters of the model by optimizing an objective function that is a divergence between a model representing a probability distribution of the censored data expressed using a probability density function of observation data, the probability density function being represented by a mixture model of each component representing a distribution of observed values corresponding to each sample of the censored data received by the input receiver, and a probability distribution of the censored data obtained from the censored data received by the input receiver.

2. The estimation apparatus according to claim 1,
wherein the model representing the probability distribution of the censored data is expressed using;
a probability distribution of the variable represented using the probability density function of the observation data and a length of a time to an observation end given in advance for each sample, and
a probability distribution of the observation data with the variable being given, the variable being represented using the probability density function of the observation data and the length of the time to the observation end given in advance for each sample.

3. The estimation apparatus according to claim 1,
wherein the objective function is a Kullback-Leibler divergence or an L2 divergence between the model representing the probability distribution of the censored data and the probability distribution of the censored data.

4. An estimation method for estimating parameters of a model representing a probability distribution of censored data, the censored data including observation data of a sample with an observed value being observed, observation data of a sample with no observed value being observed, and a variable representing whether or not an observed value is observed for each sample, the method comprising:
receiving, by an input receiver, input of the censored data; and
estimating, by a parameter estimation receiver, the parameters of the model by optimizing an objective function that is a divergence between a model representing a probability distribution of the censored data expressed using a probability density function of observation data, the probability density function being represented by a mixture model of each component representing a distribution of observed values corresponding to each sample of the censored data received by the input receiver, and a probability distribution of the censored data obtained from the censored data received by the input receiver.

5. A computer-readable non-transitory recording medium storing computer-executable program instructions that when executed by a processor for estimating parameters of a model representing a probability distribution of censored data, the censored data including observation data of a sample with an observed value being observed, observation data of a sample with no observed value being observed, and a variable representing whether or not an observed value is observed for each sample, the program instructions cause the computer system to:
receiving, by an input receiver, input of the censored data; and
estimating, by a parameter estimator, the parameters of the model by optimizing an objective function that is a divergence between a model representing a probability distribution of the censored data expressed using a probability density function of observation data, the probability density function being represented by a mixture model of each component representing a distribution of observed values corresponding to each sample of the censored data received by the input receiver, and a probability distribution of the censored data obtained from the censored data received by the input receiver.

6. The estimation apparatus according to claim 2,
wherein the objective function is a Kullback-Leibler divergence or an L2 divergence between the model representing the probability distribution of the censored data and the probability distribution of the censored data.

7. The estimation method according to claim 4,
wherein the model representing the probability distribution of the censored data is expressed using;
a probability distribution of the variable represented using the probability density function of the observation data and a length of a time to an observation end given in advance for each sample, and
a probability distribution of the observation data with the variable being given, the variable being represented using the probability density function of the observation data and the length of the time to the observation end given in advance for each sample.

8. The estimation method according to claim 4,
wherein the objective function is a Kullback-Leibler divergence or an L2 divergence between the model representing the probability distribution of the censored data and the probability distribution of the censored data.

9. The computer-readable non-transitory recording medium according to claim 5,
wherein the model representing the probability distribution of the censored data is expressed using;
a probability distribution of the variable represented using the probability density function of the observation data and a length of a time to an observation end given in advance for each sample, and
a probability distribution of the observation data with the variable being given, the variable being represented using the probability density function of the observation data and the length of the time to the observation end given in advance for each sample.

10. The computer-readable non-transitory recording medium according to claim 5,
wherein the objective function is a Kullback-Leibler divergence or an L2 divergence between the model representing the probability distribution of the censored data and the probability distribution of the censored data.

11. The estimation method according to claim 7,
wherein the objective function is a Kullback-Leibler divergence or an L2 divergence between the model representing the probability distribution of the censored data and the probability distribution of the censored data.

12. The computer-readable non-transitory recording medium according to claim 9,
wherein the objective function is a Kullback-Leibler divergence or an L2 divergence between the model representing the probability distribution of the censored data and the probability distribution of the censored data.
